(19) United States
(12) Patent Application Publication
(10) Pub. No.: US 2016/0358294 A1
(43) Pub. Date: Dec. 8, 2016

(54) PRE-DISCOUNTING PHARMACY PRESCRIPTIONS

(71) Applicant: Medical Security Card Company, LLC, Tucson, AZ (US)

(72) Inventors: Paige Berger, Tucson, AZ (US); Marcus Sredzinski, Tucson, AZ (US); Shawn Ohri, San Diego, CA (US); Jerry L. Parker, Ramona, CA (US)

(21) Appl. No.: 14/728,952

(22) Filed: Jun. 2, 2015

(51) Int. Cl. G06Q 50/22; G06Q 30/02; G06Q 40/08

(52) U.S. Cl. CPC G06Q 50/22; G06Q 40/08; G06Q 30/0207

(57) ABSTRACT

A patient presents a prescription for a drug to a pharmacist who enters a claim in a Pharmacy Management System (PMS). The PMS communicates the claim to a Switch. The Switch communicates the claim to a Discount Engine (DE). In a pre-discount embodiment, the DE, assuming the pharmacist is in a Covered Pharmacy Network, calculates a discount for the drug and attaches the discount to the claim before sending the claim to a Claim Processor (CP). In a post-discount embodiment, the DE forwards the claim without any discount information to the CP; the CP analyzes the claim for insurance coverage and returns a response to the DE; and the DE (assuming pharmacist is in network and claim is qualified) calculates a discount amount. In both embodiments, the DE passes the response (with insurance coverage and/or discount information) to the Switch. The Switch passes the response to the PMS. The pharmacist uses the PMS to dispense the drug and collect an appropriate payment from the patient.

### FIELD OF THE INVENTION

The present invention generally relates to a Pharmacy Management System, a Switch, a Discount Engine and a Claim Processor (also known as a Pharmacy Benefit Manager), whereby the Discount Engine provides discounts for prescription drugs either before or after a claim is routed to the Claim Processor.

### SUMMARY OF THE INVENTION

The present invention provides systems for discounting prescription drugs for patients. A patient may present a prescription to a pharmacist (which should, throughout this specification, be understood to also include an agent of the pharmacist) for a prescription drug. The pharmacist may enter a claim for the prescription drug(s) into a Pharmacy Management System. The Pharmacy Management System may communicate the claim directly to a Discount Engine, but in preferred embodiments, the Pharmacy Management System communicates the claim to a Switch.

The Switch may be able to handle many different claims from many different Pharmacy Management Systems substantially simultaneously. The Switch may route the claim to a Discount Engine. The Discount Engine may perform a pre-discounting analysis or a post-discounting analysis of the claim from the patient for the prescription.

In a pre-discounting embodiment, the Discount Engine may analyze the claim (and possibly insert a coupon segment with a discount amount) before forwarding the claim to the Claim Processor. In a post-discounting embodiment, the Discount Engine forwards the claim, either entirely or substantially unchanged, but may analyze a response (and possibly add a discount) after the response is returned from the Claim Processor.

The Discount Engine may analyze the claim for a discount after receiving the claim from the Switch, but before sending the claim to the Claim Processor. The Discount Engine may determine whether the pharmacy is in a covered pharmacy network of pharmacies stored on a Discount Engine Database. If the pharmacy is not in the covered pharmacy network, the Discount Engine may forward the claim to the Claim Processor without a discount. If the pharmacy is in the covered pharmacy network, the Discount Engine may calculate a discount based on current network rates, maximum allowable costs (MAC) files, patient plan details and administration fees. The Discount Engine may alter the claim, by, as a non-limiting example, inserting a coupon segment into the claim indicating the discount amount. The Discount Engine may then forward the updated claim to the Claim Processor.

The Claim Processor may adjudicate the claim and determine whether the claim is covered by the patient's insurance. The Claim Processor may also determine whether to use the discount amount from the Discount Engine. The Claim Processor may create a response indicating whether the claim was approved or rejected and whether the discount amount from the Discount Engine was used. The Claim Process may then forward the response to the Discount Engine.

The Discount Engine may determine whether the Claim Processor used the discount amount. If the Claim Processor did not use the discount amount, the Discount Engine may pass the response to the Switch. If the Claim Processor did use the discount amount, the Discount Engine may store the details in a Discount Engine database before passing the response to the Switch. In other embodiments, the Discount Engine may store the details in a Discount database regardless of whether or not the Claim Processer used the discount amount.

In the post-discounting embodiment, the Discount Engine does not analyze the claim for a discount after receiving the claim from the Switch. Instead, the Discount Engine sends the claim, substantially as received, to the Claim Processor. The Claim Processor may process the claim against the patient's pharmacy benefit (formula, coverage rules, etc.). The Claim Processor may create a response indicating whether the claim was or was not approved. The Claim Processor may communicate the created response to the Discount Engine.

The Discount Engine may analyze the response received from the Claim Processor. If the response indicates the claim was approved by the Claim Processor and/or the claim was a duplicate, the Discount Engine may pass the response, with the approved claim, to the Switch.

The Discount Engine may determine if the pharmacy is in the covered pharmacy network and/or whether the claim is qualified for a discount. A claim may be qualified based on any number or type of desired elements as determined by the Discount Engine and/or pharmacist. If the pharmacy is not in the covered pharmacy network and/or the claim is not qualified for a discount, the Discount Engine may pass the response, without indicating a discount, to the Switch.

If the pharmacy is in the covered pharmacy network and the claim is qualified for a discount, the Discount Engine may calculate a discount based on the network rates, maximum allowable costs (MAC) files, patient plan details and/or administration costs. The details regarding the claim may be stored in the Discount Engine Database. The Response may be updated to indicate the approved discount amount and passed to the Switch.

In both the pre-discounting and the post-discounting embodiments, the Switch, after receiving the response from the Discount Engine, may communicate the response to the same Pharmacy Management System that sent the corresponding claim. The pharmacist may use the Pharmacy Management System to appropriately dispense the prescription drug to the patient and collect any payment owed. The payment owed reflects the insurance coverage determined by the Claim Processor and/or the discount amount determined by the Discount Engine.

The above features and advantages of the present invention will be better understood from the following detailed description taken in conjunction with the accompanying drawings.

### BRIEF DESCRIPTION OF THE DRAWINGS

FIG. 1 is a block diagram illustrating the flow of a prescription, claim, response and payment as the method of the invention is practiced.

FIG. 2 is a block diagram illustrating how the Pharmacy Management System, Switch, Discount Engine, and Claim Processor/Pharmacy Benefit Manager are special purpose machines and may be arranged to only communicate with each other over the Internet and/or via a direct connection.

FIG. 3 is a flow chart of a pre-discount embodiment, where a Discount Engine analyzes a claim and possibly applies a discount to the claim before the claim is sent to a Claim Processor.

FIG. 4 is a flow chart of a post-discount embodiment, where a Discount Engine analyzes a response and possibly applies a discount to the response after the response is received from a Claim Processor.

FIG. 5 is a flow chart of a pre-discount embodiment with a new claim and a request for a reversal of an original claim.

FIG. 6 is a flow chart of a post-discount embodiment with a new claim and a request for a reversal of an original claim.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

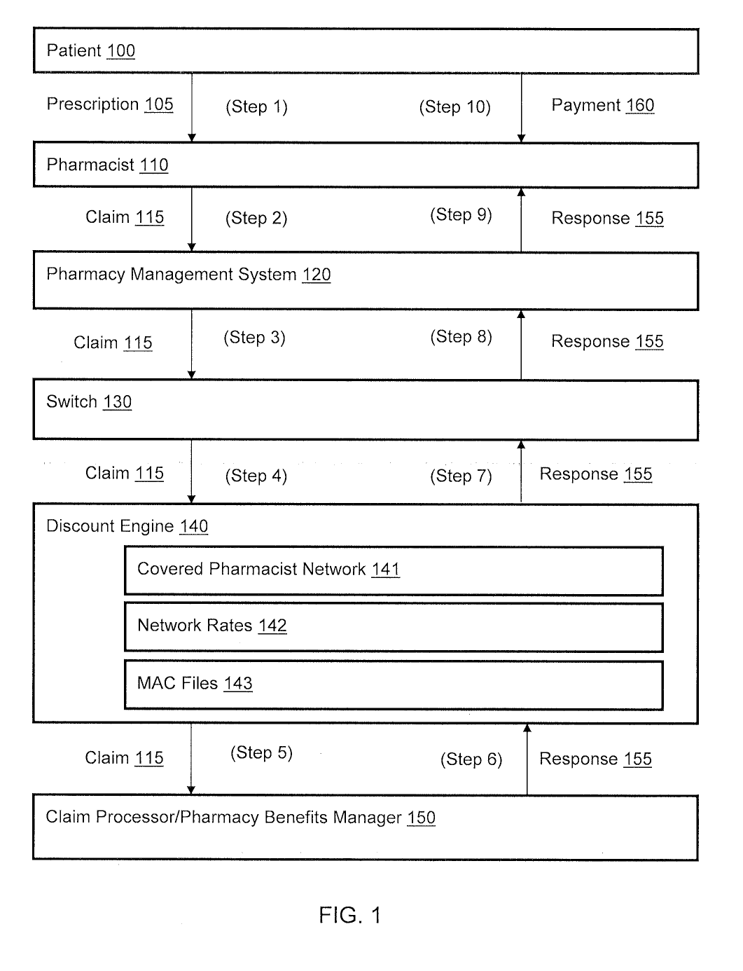

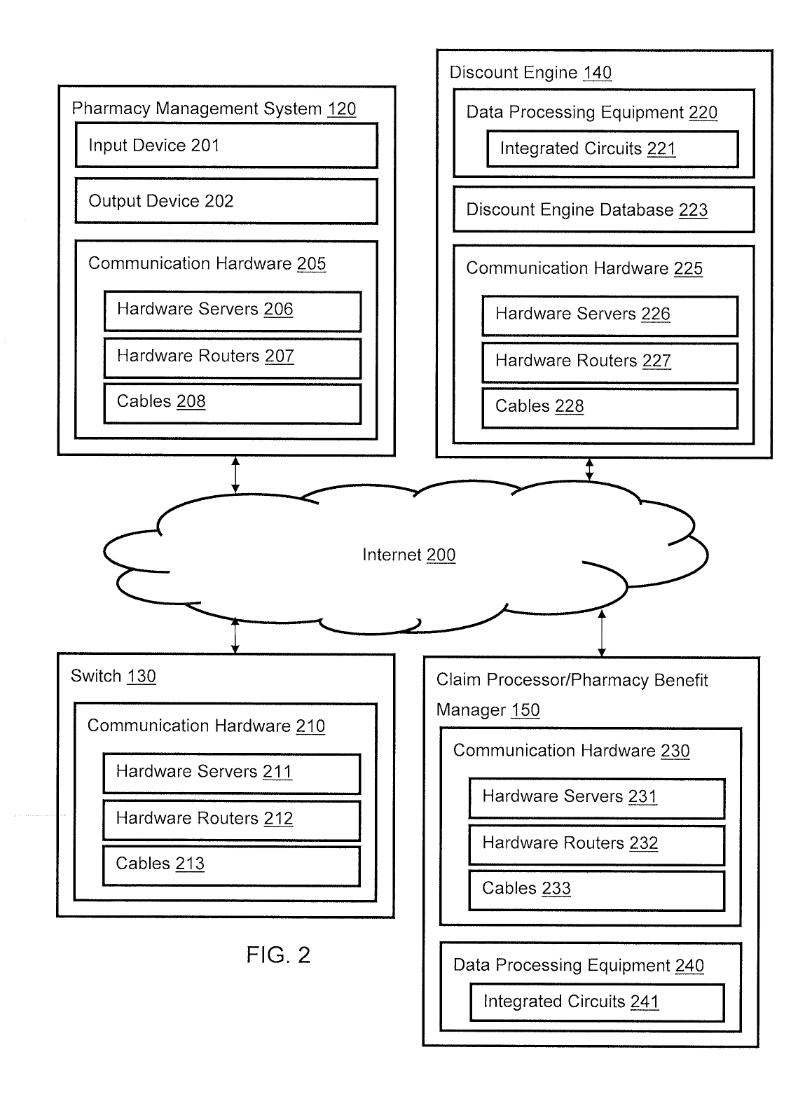

With reference to FIG. 1 and FIG. 2, a Patient 100 may be a person receiving medical care from a doctor. As part of the medical care, the doctor may prescribe one or more drugs for the Patient 100 to use. The doctor may create a prescription for the Patient 100 (which may include over-the-counter drugs as well as prescription only drugs) to receive the drugs from a pharmacist 110 or a pharmacist's agent (for simplicity, both are hereafter referred to as the pharmacist 110). The Patient 100 may deliver the prescription from the doctor to the pharmacist 110 or the doctor may forward the prescription directly to the pharmacist 110. The invention is capable of handling any number of doctors, patients 100 and pharmacists 110.

The Patient 100 may have insurance from one or more insurance providers (and thus be listed in an insurance database). The pharmacist 110 may be in a covered pharmacy network 141. The Patient 100 may, simply by requesting the purchase of the drugs and possibly by providing drug insurance or discount information, submit a claim 115 for the prescription to the pharmacist 110.

The pharmacist 110 may enter the claim 115 into a Pharmacy Management System 120. The Pharmacy Management System 120 is defined to be a special purpose machine comprising electrical and mechanical devices. Some of the special purposes of the Pharmacy Management System 120 are to receive a claim 115 entered by a pharmacist 110, communicate the claim 115 over the Internet 200 to a Switch 130, receive a response 155 over the Internet 200 from the Switch 130 and communicate information regarding the response 155 to the pharmacist 110 to permit the pharmacist 110 to dispense the drug(s) and collect the proper payment from the Patient 100. While the Pharmacy Management System 120 will typically include software, it is also hereby defined so that it includes special purpose electronic hardware. The Pharmacy Management System 120 includes an input device 201 (such as an electronic keyboard or scanning device) for a pharmacist 110 to enter a claim 115 from a Patient 100 into the Pharmacy Management System 120. The Pharmacy Management System 120 includes communication hardware 205 (such as hardware servers 206, hardware routers 207 and cables 208) to permit the claim 115 to be communicated from the Pharmacy Management System 120, over the Internet 200, to the Switch 130. The Pharmacy Management System 120 includes communication hardware 205 to permit a response 155 to be communicated from the Switch 130 to the Pharmacy Management System 120. The Pharmacy Management System 120 also includes an output device 202 to inform the pharmacist 110 of information related to the response 155. After the pharmacist 110 receives the response 155, the pharmacist 110 may dispense the drug(s) and collect the appropriate payment from the Patient 100. The appropriate payment is based on any insurance coverage and/or discounts the Patient 100 is entitled for the prescribed drug(s) as determined by the Discount Engine 140 and/or the Claim Processor 150.

The Internet 200 is defined to be a worldwide network of computer hardware and computer networks arranged to allow for the easy and robust exchange of information across large geographical distances. Communications over the Internet 200 may, as non-limiting examples, include Internet Protocol Address and ports to identify recipients of information. The Internet may also include direct connect high speed data lines dedicated to communicating data between the Pharmacy Management System 120, the Switch 130, the Discount Engine 140 and/or the Claim Processor 150. If data lines are used, these may be restricted from general public use and used solely by the Pharmacy Management System 120, the Switch 130, the Discount Engine 140 and/or the Claim Processor 150. For the purposes of this specification, all “hardware” devices (such as hardware servers and hardware routers) may include or use software, but they also include electrical and/or mechanical devices that are more than mere software.

The Switch 130 may receive claims 115 from one or more Pharmacy Management Systems 120. The Switch 130 is defined to be a special purpose machine comprising electrical and mechanical devices. Some of the special purposes of the Switch 130 are to receive claims 115 over the Internet 200 from the one or more Pharmacy Management Systems 120, communicate the claims 115 over the Internet 200 to a Discount Engine 140, receive a response 155 from the Discount Engine 140 and communicate information regarding the response 155 to the appropriate Pharmacy Management System 120 associated with the claim 115. While the Switch 130 may include and run software, the Switch 130 is also hereby defined to include special purpose electronic hardware. The Switch 130 includes communication hardware 210 (such as hardware servers 211, hardware routers 212 and cables 213) to receive claims 115 from one or more Pharmacy Management Systems 120. The Switch 130 includes communication hardware 210 to permit the claim 115 to be communicated from the Switch 130, over the Internet 200, to the Discount Engine 140. The Switch 130 includes communication hardware 210 to receive a response 155 from the Discount Engine 140. The Switch 130 also includes communication hardware 210 to communicate the response 155 to the appropriate Pharmacy Management System 120.

The Discount Engine 140 may receive claims 115 over the Internet 200 from the Switch 130. The Discount Engine 140 is defined to be a special purpose machine comprising electrical and mechanical devices. Some of the special purposes of the Discount Engine 140 are to receive claims 115 over the Internet 200 from the Switch 130, communicate the claims 115 over the Internet 200 to a Claim Processor 150 (which may also be known as a Pharmacy Benefit Manager) out of a possible plurality of Claim Processors, receive a response 155 from the Claim Processor 150, communicate the response 155 to the Switch 130 and analyze the claim 115 from the Switch 130 and/or the response 155 from the Claim Processor 150 to determine whether a pharmacist 110 is in a covered pharmacy network 141 and/or whether the Patient 100 is entitled to a discount for the drug(s) identified in the claim 115 or response 155. While the Discount Engine 140 may include software, it is also hereby defined so that it also includes special purpose electronic hardware. The Discount Engine 140 includes communication hardware 225 (such as hardware servers 226, hardware routers 227 and cables 228) to receive claims 115 from the Switch 130. The Discount Engine 140 includes communication hardware 225 to permit the claim 115 to be communicated from the Discount Engine 140, over the Internet 200, to the Claim Processor 150. The Discount Engine 140 includes communication hardware 225 to receive a response 155 from the Claim Processor 150. The Discount Engine 140 includes communication hardware 225 to communicate the response 155 to the Switch 130. The Discount Engine 140 includes data processing equipment 220 (such as microprocessors and integrated circuits 221) to analyze claims 115 and/or responses 155, to determine if pharmacists are listed in a covered pharmacy network 141, to insert coupons into claims 115 and/or to determine if a Patient 100 is eligible for a discount. The Discount Engine 140 comprises a Discount Engine Database 223 for storing the covered pharmacy network 141, network rates 142 and/or MAC files 143. While the Discount Engine Database 223 may use software, the Discount Engine Database 223 is hereby defined to be a physical electronic storage device having a physical storage medium. In preferred embodiments, the Discount Engine 140 may be a standalone system and only communicate with the Switch 130 and the Claim Processor 150 through the Internet 200 during the processes of communicating and analyzing claims 115 and/or responses 155. In this preferred embodiment the Discount Engine 140 does not share a building or hardware, other than through Internet connections, with the Switch 130 or the Claim Processor 150. In other embodiments, the Discount Engine 140 may be incorporated into the Claim Processor 150 and thus communicate with the Claim Processor 150 and/or the Switch 130 by any desired method of electronic communication.

A single stand alone Discount Engine 140 may handle claims 115 from a single or multiple Switches 130 and/or a single or multiple Pharmacy Management Systems 120. A single stand alone Discount Engine 140 may also interface and work with a single or multiple Claim Processors 150 (or Pharmacy Benefit Manager). The benefits of a stand alone Discount Engine 140 are that network rates 142 and MAC files 143 only have to be loaded, stored and maintained at one place, i.e., the Discount Engine 140. There is no need to load, store or maintain the covered pharmacy network 141, network rates 142 and/or MAC files 143 on one or more Pharmacy Management Systems 120 and/or one or more Claim Processors 150. This makes the overall system (Pharmacy Management System(s) 120, Discount Engine 140 and Claim Processor(s) 150) much easier to update and maintain. This also reduces the number of updates to Claim Processor(s) 150, reduces or eliminates feedback reporting from the Claim Processor(s) 150 and allows pharmacy billing to be handled directly by the Discount Engine 140 and secures proprietary information (MAC files, network rates, etc.).

In some embodiments, the Discount Engine 140 may have a support layer. As non-limiting examples, the Discount Engine 140 may have the ability to analyze and report discount usage for patients, manage network and rate information, automate pharmacy billing and provide customer/client service. In some embodiments, the support layer may include an administrative portal for loading and extracting data. The administrative portal may allow configuration data to be setup related to the qualification and viewing of claims. Network and MAC file data may be handled through data loads via file transfer. Pharmacy billing may be handled through data extracts into systems that handle pharmacy invoicing.

The Claim Processor 150 (also known as a Pharmacy Benefit Manager) may receive a claim 115 (possibly with a coupon segment added by the Discount Engine 140) from the Discount Engine 140. The Claim Processor 150 is defined to be a special purpose machine comprising electrical and mechanical devices. Some of the special purposes of the Claim Processor 150 are to receive claims 115 over the Internet 200 from the Discount Engine 140, adjudicate the claim 115 to determine insurance coverage for all claims 115 received, prepare a response 155 to for each claim 115 and communicate the response 155 over the Internet 200 to the Discount Engine 140. While the Claim Processor 150 may include software, it is also hereby defined to include special purpose electronic hardware. The Claim Processor 150 includes communication hardware 230 (such as hardware servers 231, hardware routers 232 and cables 233) to receive claims 115 from the Discount Engine 140. The Claim Processor 150 includes data processing equipment 240 (such as microprocessors and integrated circuits 241) to analyze claims 115 for insurance coverage and to prepare appropriate responses 155. The Claim Processor 150 also includes communication hardware 230 that allows the prepared response 155 to be communicated from the Claim Processor 150 over the Internet 200 to the Discount Engine 140.

Pre-Edit Discount

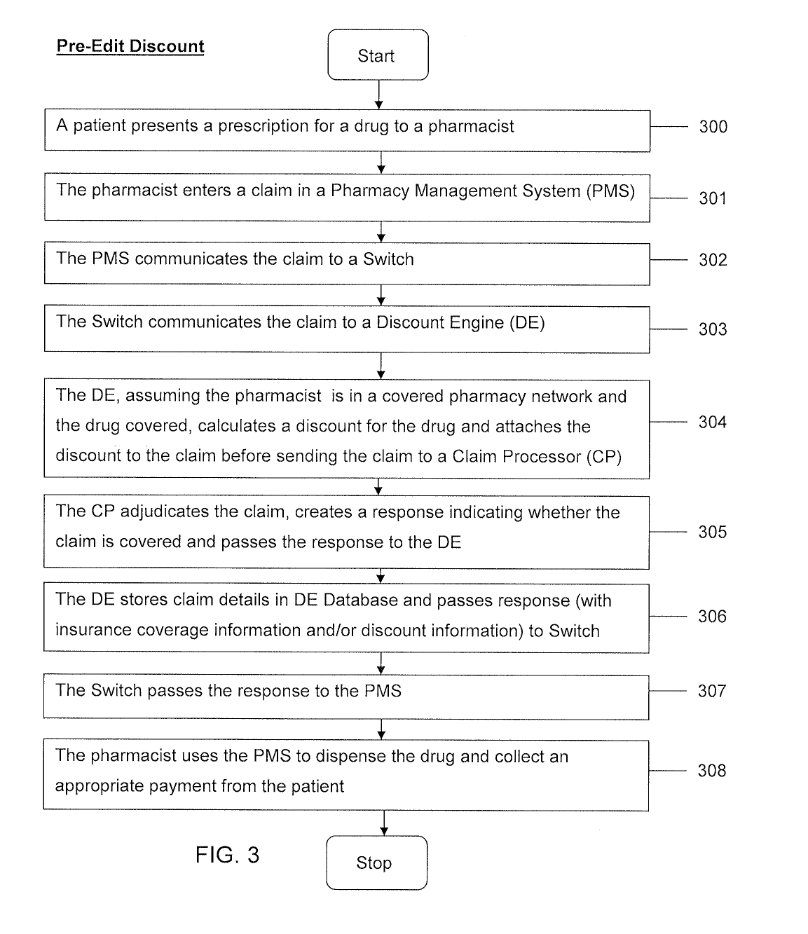

With reference to FIG. 3 (a pre-edit process), a Patient 100 may present a prescription to a pharmacist 110. (Step 300) The pharmacist 110 may enter a claim 115 on the patient's behalf for the prescription into a Pharmacy Management System 120. (Step 301) The Pharmacy Management System 120 may communicate the claim 115 over the Internet 200 to a Switch 130. (Step 302) The Switch 130 may communicate the claim 115 over the Internet 200 to a Discount Engine 140. (Step 303).

The Discount Engine 140 may analyze the claim 115 from the Switch 130 and determine whether the pharmacist 110 is listed in a covered pharmacy network 141 stored in the Discount Engine Database 223. The pharmacists in the covered pharmacy network 141 are those that have negotiated a discount drug program with the Discount Engine 140. If the pharmacist 110 is not in the covered pharmacy network 141 the Discount Engine 140 may forward the claim 115 to the Claim Processor 150 without attaching a coupon segment indicating a discount to the claim 115.

Alternatively, if the pharmacist 110 is in the covered pharmacy network 141 the Discount Engine 140 may calculate a discount based on network rates 142, maximum allowable costs (MAC) files 143 and/or administration fees. The Discount Engine 140 may insert a coupon segment to the claim 115 with the calculated discount amount. The Discount Engine 140 may then forward the claim 115 (with the inserted coupon segment) to the Claim Processor 150 for further processing. (Step 304)

Table 1 is a non-limiting example of what a claim with a coupon segment (segment is AM09) may look like:

TABLE 1

| | |
|---|---|
| 009999D0B100000000001070100886 | 20150119 |

-AM04C2PREB1TEST011C301C61-AM01C419700111C51CACARDHOLDERCBPREB
1TEST011-AM07EM1D2000000010010E103D700777310402D300D5030DE20150119
E70000030000-AM11DQ0009990{DU0009990{-AM03DBAZ9999999-AM09KE01MESS
DISCOUNTNE0000250{----------------------------------

The Claim Processor 150 may adjudicate the claim 115 to determine whether the Patient 100 and drug(s) are covered under the patient's insurance coverage using predefined rules. If the Claim Processor 150 approves the claim 115, the Claim Processor 150 may prepare a response 155 indicating the claim 115 was approved and forward the response 155 to the Discount Engine 140. If the Claim Processor 150 determines that the claim is not covered by the patient's insurance, but the claim 115 has an inserted coupon segment for a discount, the Claim Processor 150 may determine whether the claim 115 is qualified for the discount. If the claim 115 is qualified for the discount, the Claim Processor 150 may prepare a response 155 that indicates the discount was used and forward the response 155 to the Discount Engine 140. (Step 305)

The Discount Engine 140 may analyze the response 155 to determine whether the Claim Processor 150 used the discount for the Patient 100. If the discount was used by the Claim Processor 150 for the Patient 100, the Discount Engine 140 may save claim 115 details in the Discount Engine Database 223 indicating the discount was used. In other embodiments, the claim 115 details may be stored in the Discount Engine Database 223 regardless of whether or not the discount was used. The Discount Engine 140 may pass over the Internet 200 the response 155 back to the Switch 130. (Step 306) The Switch 130 may communicate over the Internet 200 the response 155 (indicating whether the claim 115 was covered and/or whether the discount was used) back to the Pharmacy Management System 120 (Step 307) so the pharmacist 110 may appropriately dispense the drug(s) and collect payment (which reflects insurance coverage and/or discount(s) used) from the Patient 100. (Step 308)

Table 2 is a non-limiting example of a pre-edit response 155 with an approved discount. This example response 155 has a field indicating that a discount was applied. Any field and any value within the field may be used to indicate whether or not a discount was applied.

TABLE 2

| | |
|---|---|
| D0B11A070100886 | 20150119-AM20F4SS DISCOUNT |

APPLIED-AM21ANDF3U15009R707BC00-AM23F5100{F650{F750{F9{FM04FI{4U100{
-AM22EM1D2000000010003-----------------------------------

Table 3 is a non-limiting example of a pre-edit response 155 without a discount, In this example, no indicator (for a discount being applied) is present.

TABLE 3

| | |
|---|---|
| D0B11A070100886 | 20150119-AM20F4NO |

MESSAGE-AM21ANDF3U15009R707BC00-AM23F5100{F650{F750{F9{FM04FI{4U10
0{-AM22EM1D2000000010003----------------------------------

Claim Reversal Processes

In another embodiment, it may be desirable to reverse (erase, undo or negate) a claim 115 that was previously approved by a Claim Processor 150 and/or a Discount Engine 140. This embodiment of reversing the claim 115 may be used after either the pre-edit process (discussed above) or the post-edit process (discussed below). The pharmacist may enter the claim 115 (to reverse) into a Pharmacy Management System 120. The Pharmacy Management System 120 may forward the claim 115 over the Internet 200 to a Switch 130. The Switch 130 may communicate the claim 115 over the Internet 200 to the Discount Engine 140. The Discount Engine 140 may forward the claim 115 over the Internet 200 to the Claim Processor 150. In preferred embodiments, the claim 115 forwarded to the Claim Processor 150 is either identical or substantially the same as when the claim 115 left the Pharmacy Management System 120. The Claim Processor 150 may adjudicate the claim 115 and either approve or deny the claim 115 reversal. The Claim Processor 150 may return a response 155 to the Discount Engine 140 indicating whether the Claim Processor 150 approved or denied the claim 115 reversal. The Discount Engine 140 may review the response 155 to determine whether the claim 115 reversal was approved or denied by the Claim Processor 150. If the claim 115 reversal was denied, the response 155 may be forwarded over the Internet 200 to the Switch 130. If the claim 115 reversal was approved, but the claim 115 was not previously discounted, the response 155 may be forwarded over the Internet 200 to the Switch 130. If the claim 115 reversal was approved and the claim 115 was originally discounted, the Discount Engine may reverse the claim in a Discount Engine Database 223 and pass the response 155 over the Internet 200 to the Switch 130. The Switch 130 may communicate over the Internet 200 the response 155 (indicating whether the Claim Process 150 reversed the claim 115 back to the Pharmacy Management System 120 so the pharmacist 110 may appropriately dispense the drug(s) and collect or refund the correct payment from the Patient 100.

Pre-Edit Discount with Claim Reversal

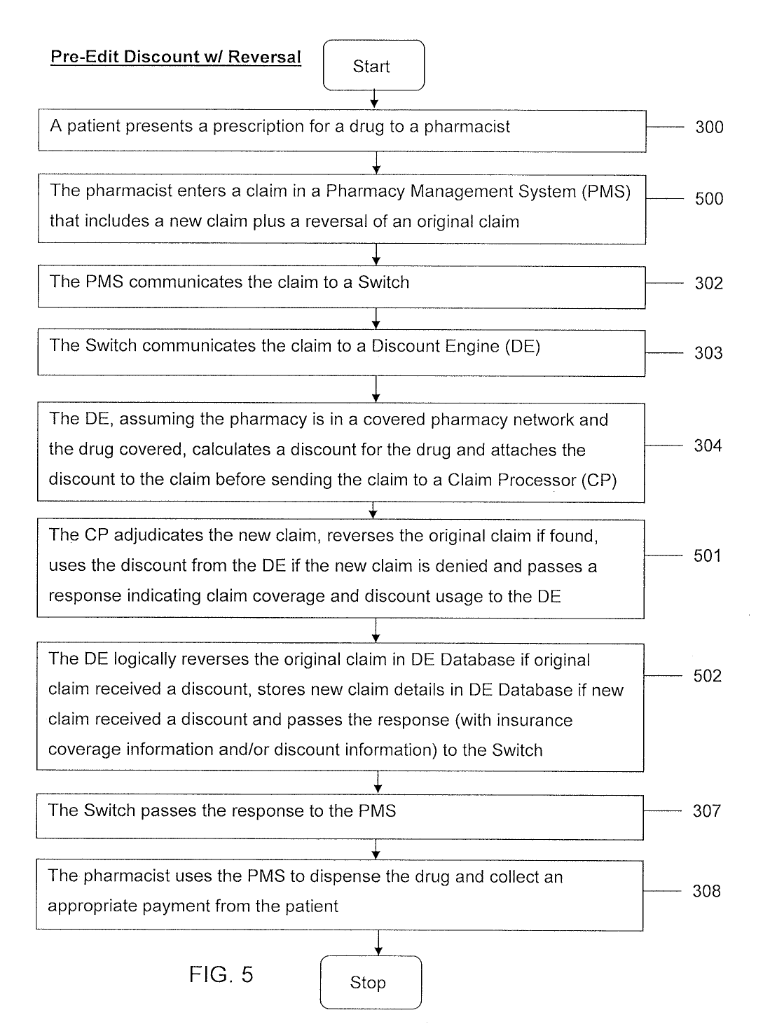

With reference to FIG. 5, a Patient 100 may present a prescription to a pharmacist 110 and possibly request a reversal of an original claim (previously approved claim). (Step 300) The pharmacist 110 may enter a new claim 115 on the patient's behalf for the prescription into a Pharmacy Management System 120 and for the reversal of the original claim. (Step 500) In some embodiments, a pharmacist 110 may need to change information on a claim, e.g., quantity, days supply, etc.) and the pharmacist 110 may submit a rebill. This rebill may be a reversal of a claim and a submission of a new claim in one transaction. The Pharmacy Management System 120 may communicate the claim 115 over the Internet 200 to a Switch 130. (Step 302) The Switch 130 may communicate the claim 115 over the Internet 200 to a Discount Engine 140. (Step 303)

The Discount Engine 140 may analyze the claim 115 from the Switch 130 before sending the claim 115 to the Claim Processor 150 and determine whether the pharmacist 110 is listed in a covered pharmacy network 141 stored in the Discount Engine Database 223. The pharmacists in the covered pharmacy network 141 are those that have negotiated a discount drug program with the Discount Engine 140. If the pharmacist 110 is not in the covered pharmacy network 141, the Discount Engine 140 may forward the claim 115 to the Claim Processor 150 without attaching a coupon segment indicating a discount to the claim 115.

Alternatively, if the pharmacist 110 is in the covered pharmacy network 141, the Discount Engine 140 may calculate a discount for the new claim 115 based on network rates 142, maximum allowable costs (MAC) files 143 and/or administration fees. The Discount Engine 140 may insert a coupon segment to the claim 115 with the calculated discount amount. The Discount Engine 140 may then forward the claim 115 (with the inserted coupon segment) to the Claim Processor 150 for further processing. (Step 304)

The Claim Processor 150 may reverse the original claim if the original claim is found in the Claim Processor's database. If the Claim Processor 150 successfully reverses the original claim, the Claim Processor 150 may then adjudicate the new claim 115 and determine whether the Patient 100 and/or the patient's prescription are covered by the Patient's insurance. If the Claim Processor 150 approves the claim 115, the Claim Processor 150 may prepare a response 155 indicating the claim 115 was approved and forward the response 155 to the Discount Engine 140. If the Claim Processor 150 does not approve the claim 115, but the claim 115 has an inserted coupon segment for a discount, the Claim Processor 150 may determine whether the claim 115 is qualified for the discount. If the claim 115 is qualified for the discount, the Claim Processor 150 may prepare a response 155 that indicates the discount was used and forward the response 155 to the Discount Engine 140. While any number of communications may occur between the Discount Engine 140 and the Claim Processor 150, in preferred embodiments all the information is sent from the Claim Processor 150 to the Discount Engine in a single response 155. (Step 501)

The Discount Engine 140 may analyze the response 155 to determine whether the Claim Processor 150 used the discount for the Patient 100. If the discount was used by the Claim Processor 150 for the Patient 100, the Discount Engine 140 may save claim 115 details in the Discount Engine Database 223 indicating the discount was used. The Discount Engine 140 may also analyze the response 155 and/or Discount Engine Database 223 to determine whether the original claim was discounted. If the original claim was discounted, the Discount Engine may logically reverse the discount in the Discount Engine Database 223. The Discount Engine 140 may pass over the Internet 200 the response 155 back to the Switch 130. (Step 502) The Switch 130 may communicate over the Internet 200 the response 155 (preferably indicating whether the claim 115 was covered, whether the discount was used and/or whether the previously approved claim was reversed as requested) back to the Pharmacy Management System 120 (Step 307) so the pharmacist 110 may appropriately dispense the drug(s) and collect payment (which reflects insurance coverage, discount(s) used and/or the original claim reversal) from the Patient 100 (Step 308).

Post-Edit Discount

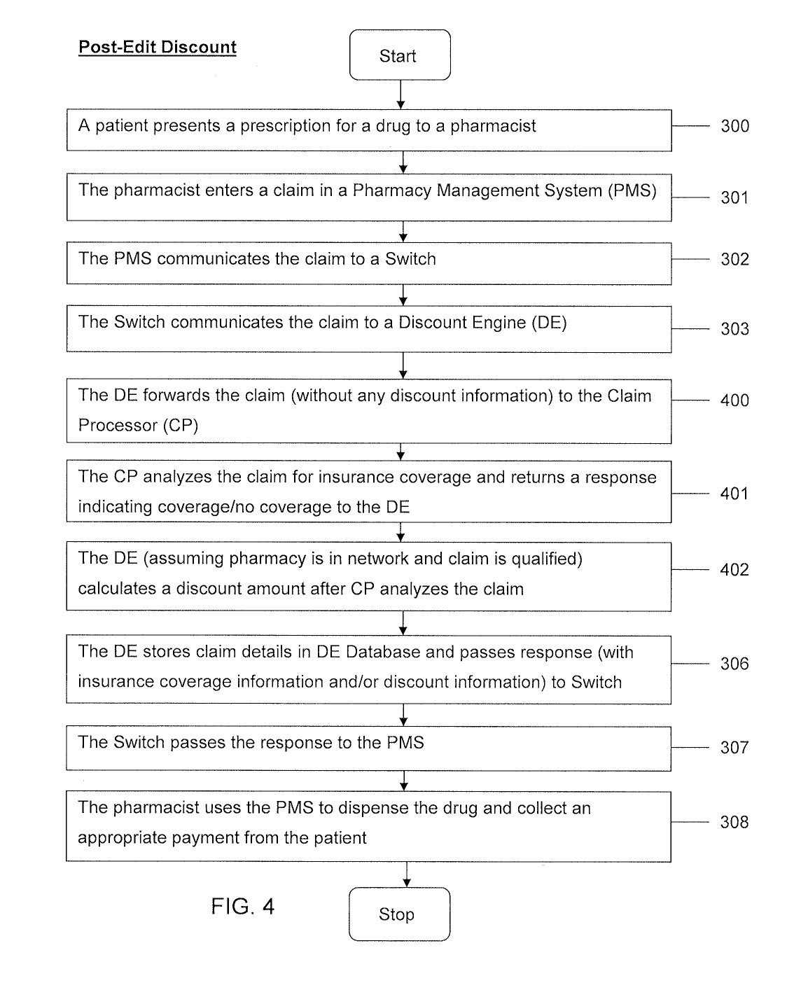

With reference to FIG. 4 (a post-edit process), a Patient 100 may present a prescription to a pharmacist 110. (Step 300) The pharmacist 110 may enter a claim 115 on the patient's behalf for the prescription into a Pharmacy Management System 120. (Step 301) The Pharmacy Management System 120 may communicate the claim 115 over the Internet 200 to a Switch 130. (Step 302) The Switch 130 may communicate the claim 115 over the Internet 200 to a Discount Engine 140. (Step 303)

The Discount Engine 140 may forward the claim 115, preferably unaltered and in the same state that the claim 115 was received, i.e., no changes or discount coupons attached, to a Claim Processor 150. (Step 400) The Claim Processor 150 may adjudicate the claim 115 and determine whether the Patient 100 and/or the patient's prescription are covered by insurance, create a response 155 to the claim 115 indicating whether the Patient 100 and/or prescription are covered by insurance and communicate the response 155, over the Internet 200, to the Discount Engine 140. (Step 401)

After receiving the response 155 from the Claim Processor 150, the Discount Engine 140 may analyze the response 155. If the response 155 indicates the Claim Processor 150 approved the claim 115, the Discount Engine 140 may pass the response 155 to the Switch 130. The Switch 130 may communicate over the Internet 200 the response 155 (indicating the Claim Processor 150 approved the claim 115) back to the Pharmacy Management System 120 so the pharmacist 110 may appropriately dispense the drug(s) and collect the correct payment from the Patient 100.

Table 4 is a non-limiting example of a response 155 in a post-edit discount process. In this example, the response 155 indicates the claim 115 was allowed by the Claim Processor 150 and thus, in this embodiment, not qualified for a discount.

TABLE 4

| | |
|---|---|
| D0B11A070100886 | 20150119-AM20F4DE TEST |

MESSAGE-AM21ANPF3U15009R707BC00-AM22EM1D2009971000001-AM23F5100{
F650{F750{F9{FI{4U100{--------------------------------

If the response 155, created by the Claim Processor 150, indicates the claim 115 was a duplicate, the Discount Engine 140 may communicate the duplicate claim 115 response 155 to the Switch 130. The Switch 130 may communicate over the Internet 200 the response 155 (indicating the Claim Processor 150 found the claim 115 to be a duplicate) back to the Pharmacy Management System 120 so the pharmacist 110 may appropriately dispense the drug(s) and collect the correct payment from the Patient 100.

If the claim 115 was rejected and found not to be a duplicate by the Claim Processor 150, the Discount Engine 140 may determine whether the pharmacist 110 is in the covered pharmacy network 141, and determine whether the claim 115 is qualified for a discount. If the pharmacist 110 is not part of the covered pharmacy network 141 of covered pharmacists or if the claim 115 is not qualified for a discount, the Discount Engine 140 may pass the response 155, without an approved discount, to the Switch 130. The Switch 130 may communicate over the Internet 200 the response 155 (indicating no qualified discount) back to the Pharmacy Management System 120 so the pharmacist 110 may appropriately dispense the drug(s) and collect the correct payment from the Patient 100.

Table 5 is a non-limiting example of a response 155 in a post-edit discount process. In this example, the response 155 indicates the claim was rejected by the Claim Processor 150 and no discount was applied by the Discount Engine 140.

TABLE 5

D0B11A070100886

20150119-AM21ANRF3U14310S434BC01FA1FB75-AM22EM1D2009971000002
----------------------------------

Table 6 is a non-limiting example of a response 155 in a post-edit discount process. In this example, the response 155 indicates the claim was rejected by the Claim Processor 150, but the Discount Engine applied a discount to the response 155.

TABLE 6

D0B11A070100886

20150119-AM21ANRF3U14310S434BC01FA1FB70-AM22EM1D2009971000003
----------------------------------

If the claim 115 was rejected and found not to be a duplicate by the Claim Processor 150 and the pharmacist 110 100 is in the covered pharmacy network 141 and the claim 115 is qualified for a discount, the Discount Engine 140 may calculate a discount using network rates 142, the patient's plan, MAC files 143 and administration fees. The response 155 may be modified and/or a new response 155 may be created to indicate that a discount may be provided to the Patient 100. (Step 402) In preferred embodiments, the claim 115 details (patient name, drug(s), claim 115 details, date, determinations made by the Claim Processor 150 and/or Discount Engine 140) may be stored in the Discount Engine Database 223. The Discount Engine 140 may pass the response 155, with the approved discount, to the Switch 130. (Step 306) The Switch 130 may communicate over the Internet 200 the response 155 (indicating the Discount Engine 140 approved a discount) back to the Pharmacy Management System 120 (Step 307) so the pharmacist 110 may appropriately dispense the drug(s) and collect the correct payment from the Patient 100 (Step 308).

Post-Edit Discount with Claim Reversal

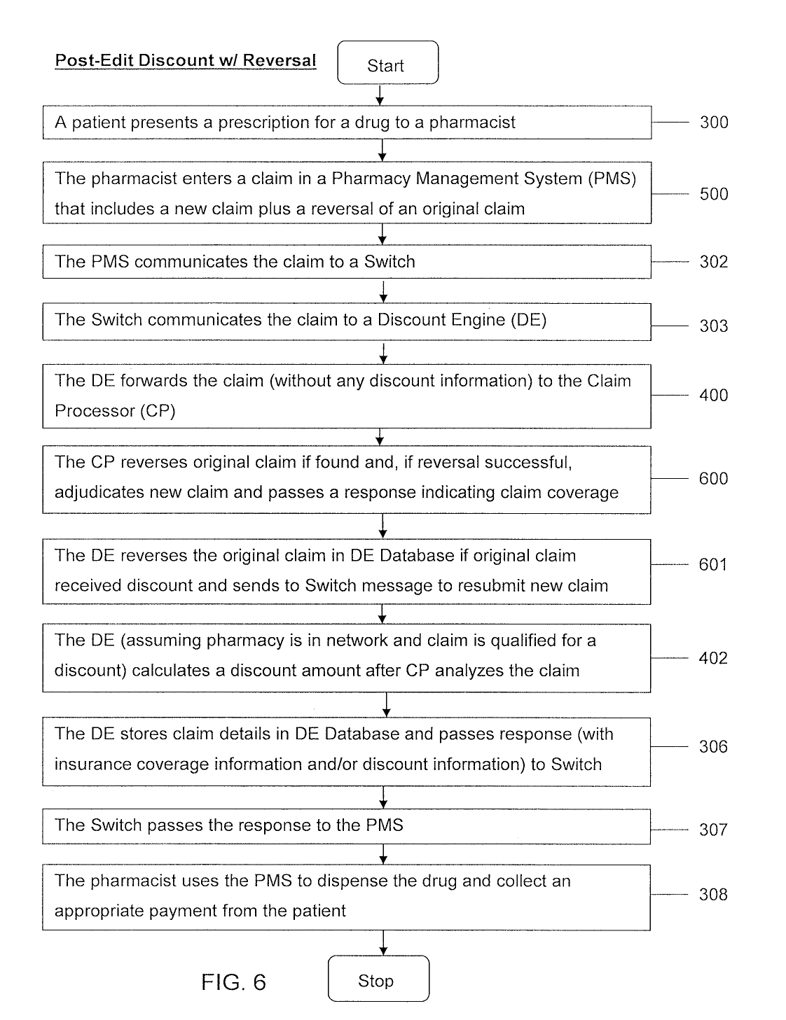

With reference to FIG. 6, a Patient 100 may present a prescription to a pharmacist 110 and possibly request a reversal of an original claim (previously approved claim). (Step 300) A pharmacist 110 may need to change information on a claim (e.g., quantity, days supply, etc.) and may submit a rebill. The rebill may be a reversal of an original claim and a submission of a new claim all in one transaction. The pharmacist 110 may enter a claim 115 (possibly a rebill) on the patient's behalf for the prescription into a Pharmacy Management System 120 and for the reversal of the original claim. (Step 500) The Pharmacy Management System 120 may communicate the claim 115 over the Internet 200 to a Switch 130. (Step 302) The Switch 130 may communicate the claim 115 over the Internet 200 to a Discount Engine 140. (Step 303)

The Discount Engine 140 may forward the claim 115, preferably unaltered and in the same state that the claim 115 was received, i.e., no changes or discount coupons attached, to a Claim Processor 150. (Step 400) The Claim Processor 150 may reverse the original claim if found in the Claim Processor database. If the Claim Processor 150 was able to successfully reverse the original claim, the Claim Processor 150 may then adjudicate the new claim and determine whether the patient 100 and/or the patient's prescription are covered by the patient's insurance. The Claim Processor 150 may create a response 155 indicating whether the original claim was reversed and/or the Patient 100 and/or prescription are covered by insurance. The Claim Processor 150 may communicate the response 155, over the Internet 200, to the Discount Engine 140. (Step 600)

The Discount Engine 140 may determine whether the original claim, now being reversed, was previously discounted. If the original claim was discounted, the Discount Engine may logically reverse the discount in the Discount Engine Database 223, generate an accepted/rejected response and forward to the Switch 130 with a message to resubmit as a new claim. (Step 601)

If the response 155 indicates the Claim Processor 150 approved the claim 115, the Discount Engine 140 may pass the response 155 to the Switch 130. The Switch 130 may communicate over the Internet 200 the response 155 (indicating the Claim Processor 150 rejected the claim 115) back to the Pharmacy Management System 120 so the pharmacist 110 may appropriately dispense the drug(s) and collect the correct payment from the Patient 100.

If the response 155 indicates the claim 115 was rejected by the Claim Processor 150, the Discount Engine 140 may determine whether the pharmacist 110 is in the covered pharmacy network 141. If the pharmacist 100 is not part of the covered pharmacy network 141 of covered pharmacists or if the claim 115 is not qualified for a discount, the Discount Engine 140 may pass the response 155, without an approved discount, to the Switch 130. The Switch 130 may communicate over the Internet 200 the response 155 (indicating no qualified discount) back to the Pharmacy Management System 120 so the pharmacist 110 may appropriately dispense the drug(s) and collect the correct payment from the Patient 100.

If the response 155 indicates the claim 115 was rejected, the pharmacist 110 is in the covered pharmacy network 141 and the claim 115 is qualified for a discount, the Discount Engine 140 may calculate a discount using network rates 142, the patient's plan, MAC files 143 and administration fees. (Step 402) The response 155 may be modified, or a new response 155 created, to indicate that a discount may be provided to the Patient 100. In preferred embodiments, the claim 115 details (patient name, drug(s), claim 115 details, date, determinations made by the Claim Processor 150 and/or Discount Engine 140, etc.) may be stored in the Discount Engine Database 223. The Discount Engine 140 may pass the response 155, with the approved discount, to the Switch 130. (Step 306) The Switch 130 may communicate over the Internet 200 the response 155 (indicating the Discount Engine 140 approved a discount) back to the Pharmacy Management System 120 (Step 307) so the pharmacist 110 may appropriately dispense the drug(s) and collect/refund the correct payment from the Patient 100 (Step 308).

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A method for a Discount Engine to pre-edit a claim, comprising the steps of:
a) the Discount Engine receiving over the Internet the claim from a Switch comprising one or more hardware routers, wherein the Switch received the claim from a Pharmacy Management System, wherein the Pharmacy Management System received the claim from a pharmacy and the pharmacy received a prescription from a patient, wherein the Discount Engine comprises electronic hardware and software, and wherein during the method the Discount Engine only communicates with the Switch and a claim Processor through the Internet;
b) if, and only if, the pharmacy is within a Covered Pharmacy Network, then:
i) the Discount Engine calculating a discount; and
ii) the Discount Engine inserting a coupon segment with the discount to the claim;
c) the Discount Engine forwarding over the Internet the claim to the claim Processor, wherein the claim Processor creates a response indicating whether the discount was used by the claim Processor;
d) the Discount Engine receiving over the Internet the response from the claim Processor;
e) the Discount Engine storing a plurality of data regarding the discount in a Discount Engine Database; and
f) the Discount Engine passing over the Internet the response to the Switch, wherein the Switch passes the response to the Pharmacy Management System.

2. The method of claim 1, wherein the Discount Engine is a stand alone system and does not share a building and/or any hardware with the Pharmacy Management System, the Switch and the claim Processor other than through Internet connections.

3. The method of claim 1, further comprising the step of:
g) updating the Covered Pharmacy Network at the Discount Engine and not at the claim Processor as pharmacists enter and/or leave the Covered Pharmacy Network.

4. The method of claim 1, further comprising the step of:
g) updating the network rates and/or Maximum Allowable Costs at the Discount Engine and not at the claim Processor as network rates change and/or Maximum Allowable Costs change.

5. The method of claim 1, wherein the Discount Engine calculates the discount before forwarding over the Internet the claim to the claim Processor.

6. A method for a Pharmacy Management System to submit a pre-edit claim, comprising the steps of:
a) the Pharmacy Management System receiving a claim of a patient from a pharmacist, wherein the Pharmacy Management System comprises electronic hardware and software;
b) the Pharmacy Management System transmitting over the Internet the claim to a Switch comprising one or more hardware routers, wherein:
i) the Switch transmits over the Internet the claim to a Discount Engine;
ii) if, and only if, the pharmacy is within a Covered Pharmacy Network, then:
A) the Discount Engine calculates a discount; and
B) the Discount Engine inserts a coupon segment with the discount to the claim;
iii) the Discount Engine forwards over the Internet the claim to the claim Processor, wherein the claim Processor creates a response indicating whether the discount was used by the claim Processor;
iv) the Discount Engine receives over the Internet the response from the claim Processor;
v) the Discount Engine stores a plurality of data regarding the discount in a Discount Engine Database; and
vi) the Discount Engine passes over the Internet the response to the Switch; and
c) the Pharmacy Management System receiving the response from the Switch.

7. The method of claim 6, wherein the Discount Engine is a stand alone system and does not share a building and/or any hardware with the Pharmacy Management System, the Switch and the claim Processor other than Internet connections.

8. The method of claim 6, wherein the Covered Pharmacy Network is periodically updated at the Discount Engine and not at the claim Processor as pharmacists enter and/or leave the Covered Pharmacy Network.

9. The method of claim 6, wherein the network rates and/or Maximum Allowable Costs are periodically updated at the Discount Engine and not at the claim Processor as network rates change and/or Maximum Allowable Costs change.

10. The method of claim 6, wherein the Discount Engine calculates the discount before forwarding over the Internet the claim to the claim Processor.

11. A method for a claim Processor to receive a pre-edit claim, comprising the steps of:
a) the claim Processor receiving over the Internet the claim with a coupon segment with a discount from a Discount Engine, wherein the Discount Engine received over the Internet the claim from a Switch comprising one or more hardware routers, wherein the Switch received the claim from a Pharmacy Management System, wherein the Pharmacy Management System received the claim from a patient, wherein the Discount Engine comprises electronic hardware and software, and wherein during the method the Discount Engine only communicates with the Switch and the claim Processor through the Internet;
b) the claim Processor creating a response indicating whether the claim was covered and whether the discount was used by the claim Processor; and
c) the claim Processor sending the response to the Discount Engine, wherein the Discount Engine passes over the Internet the response to the Switch, and wherein the Switch passes the response to the Pharmacy Management System.

12. The method of claim 11, wherein the Discount Engine is a stand alone system and does not share a building and/or any hardware with the Pharmacy Management System, the Switch and the claim Processor other than Internet connections.

13. The method of claim 11, wherein a Covered Pharmacy Network is periodically updated at the Discount Engine and not at the claim Processor as pharmacists enter and/or leave the Covered Pharmacy Network.

14. The method of claim 11, wherein a network rates are periodically updated at the Discount Engine and not at the claim Processor as network rates change.

15. The method of claim 11, wherein the Discount Engine calculates the discount before forwarding over the Internet the claim to the claim Processor.

16. A method for a Switch to route a pre-edit claim, comprising the steps of:
a) the Switch, comprising one or more routers, receiving over the Internet the claim from a Pharmacy Management System, wherein the Pharmacy Management System receives the claim from a Pharmacist;
b) the Switch transmitting over the Internet the claim to a Discount Engine, wherein during the method the Discount Engine, comprising electronic hardware and software, only communicates with the Switch and a claim Processor through the Internet, wherein if, and only if, the Pharmacist is within a Covered Pharmacy Network, then:
i) the Discount Engine calculates a discount;
ii) the Discount Engine inserts a coupon segment with the discount to the claim;
iii) the Discount Engine forwards over the Internet the claim to the claim Processor, wherein the claim Processor creates a response indicating whether the discount was used by the claim Processor; and
iv) the Discount Engine receives over the Internet the response from the claim Processor;
c) the Switch receiving over the Internet the response from the Discount Engine; and
d) the Switch transmitting the response to the Pharmacy Management System.

17. The method of claim 16, wherein the Discount Engine is a stand alone system and does not share a building and/or any hardware with the Pharmacy Management System, the Switch and the claim Processor other than Internet connections.

18. The method of claim 16, wherein a Covered Pharmacy Network is periodically updated at the Discount Engine and not at the claim Processor as pharmacists enter and/or leave the Covered Pharmacy Network.

19. The method of claim 16, wherein a network rates are periodically updated at the Discount Engine and not at the claim Processor as network rates change.

20. The method of claim 16, wherein the Discount Engine calculates the discount before forwarding over the Internet the claim to the claim Processor.
